(19) United States
(12) Patent Application Publication
(10) Pub. No.: US 2005/0096938 A1
(43) Pub. Date: May 5, 2005

(54) System and method for providing and access-controlling electronic content complementary to a printed book

(75) Inventors: Steven J. Slomkowski, Portland, OR (US); Michael D. Whitesel, Portland, OR (US)

Correspondence Address: IDEA ADVOCATES LAW GROUP LLC, 322 NW 5TH AVE #310, PORTLAND, OR, 97209, US

(73) Assignee: Zurimedia, Inc., Portland, OR (US)

(21) Appl. No.: 10/979,543

(22) Filed: Nov. 1, 2004

Related U.S. Application Data
(60) Provisional application No. 60/515,502, filed on Oct. 30, 2003.

(51) Int. Cl. G06F 17/60

(52) U.S. Cl. 705/1

(57) ABSTRACT

A system and method for publishing electronic content including a facsimile copy of a printed book while providing access and navigation for the electronic content via the printed book itself. Each printed book serves as a static representation of the foundational part of the electronic multimedia content. The printed book also serves as the primary means for access to and navigation of the complete multimedia content.

### RELATED APPLICATIONS

The present application claims priority to U.S. Provisional Patent Application Ser. No. 60/515,502, entitled MULTIMEDIA INFORMATION SYSTEM ACCESSED VIA PRINTED-BOOK and filed Oct. 30, 2003, which is assigned to Zurimedia, Inc., Portland, Oreg., USA (hereinafter simply Zuri™), the disclosure of which is incorporated herein in its entirety by this reference.

### BACKGROUND OF THE INVENTION

This invention relates generally to the field of publishing, and in particular, to a convergence of printed books and Internet publishing.

For much of the 20^{th} century, trade publishing of new hard bound books has been seen as a break-even operation. It was believed that profit would come when books reached a broader audience through book clubs or paperback sales. (See A. Schiffrin, The Business of Books, at p. 104, Verso 2000.) After twenty or more years of consolidation and commercialization, the book publishing industry and most of its component—authors, agents, publishers, marketers and retailers—have resigned themselves to the businesslike, margin-driven culture of the industry today. (See F. Barringer, “Genteel Changes To Hardscrabble In Publishing”, New York Times, at B7, Jan. 18, 2003.) Although Bowker's database of publishers lists over 50,000 publishers, nonetheless, the top twenty firms control 93% of the market. (See A. Schiffrin, The Business of Books, at p. 126, Verso 2000.) Many of the top publishers are now subsidiaries of major media conglomerates. As one publishing house after another has been taken over by conglomerates, the new owners insist that their new book division(s) generate the kind of revenues and profits their newspapers, cable television networks, and films do-businesses that have always enjoyed far higher profit margins (12-15%). (See A. Schiffrin, The Business of Books, at pp. 18-119, Verso 2000.)

A number of market trends confront book publishers, including: 1) Tight budgets pressuring managers to make every title profitable; 2) Disruptive technologies, such as the Internet, threatening loss of readership (corresponding to increased consumer time spent on the Internet, especially true in the young adult market) (see L. Kopp, “Media Industry Pressures are Bearing Down Harder on Publishers”, Circulation Management at p. 6, August 2003); 3) Decreased profit margins due to increased discounts to retailers, larger upfront guarantees to authors and higher production costs; 4) Inability to forecast final sales due to unpredictable returns of unsold books from the book trade; 5) Increased competition from national chain retail booksellers moving into publishing; 6) A lack of consumer feedback; and 7) The proliferation of used books. (See S. Zeitchik, “Publishers Debate Range of Issues at AAP Meeting”, Publishers Weekly, Mar. 1, 2004.)

There are two main channels for selling books today, the traditional retail book trade and the specialty books trade. Competition is fierce for both. In the retail book trade, large chain retailers control most of the market through cozy relationships with wholesalers and distributors. In the specialty book trade, mass merchandisers (i.e. Amazon.com, Wal-Mart) now account for a growing portion of all general trade book sales (see H. Green, “Selling Books Like Bacon”, BusinessWeek at http://www.businessweek.com/magazine/content/03_{—}24/b3837103.htm, Jun. 16, 2003), thereby increasing competition in the retail sale of books.

Trade book sales are not tracked in close detail. The primary industry figures are tracked by categories that mix topics, formats and audiences.

Pricing for books varies by format and topic. Hardcover books are priced significantly higher than paperbacks. This is true in part because new titles are initially released as hardcover and can fetch a higher price. Paperback books cost only marginally less to print than hardcover.

Profitability in the traditional book trade channel rests on generally accepted terms for expected margins at each step along the sales channel to the consumer. This typically follows from the publisher to the distributor, then to the wholesaler and on to the bookstore. Of the retail price, the retail bookstore typically retains 40%. After the wholesaler and distributor take their slices, the publisher earns about 35% of the retail price with about 9% of this contributing to profit. So, of a $20 retail price, the publisher would only have $7 to cover all costs, leaving about $0.63 for profit.

The entertainment category as a whole is anxious for a new burst of technology to propel demand (see “Entertainment & Media Industry Almanac”, Plunkett Research, 2004 at http://www.plunkettresearch.com/entertainment/entertainment_trends.htm), and book publishers are no exception. Attempts have been made to innovate in publishing. Printing technology is one area that has seen great improvements in recent years. For example, the lower cost and higher quality of on-demand printing have helped make vanity publishing and short run titles more viable. As another example, desktop publishing (which is more of a process than a product) has become widespread in the last two decades.

Reading on-line in various forms has proliferated because of the Internet. Thus the ubiquity of personal computers (PCs) makes more frequent on-line readers of everyone. People are increasingly turning to the Internet for their information and entertainment needs. The rapid increase in broadband usage reveals that demand for even more rich content remains strong. (See Nielsen//NetRatings “Increased Number of Broadband Connections Drive Rich Media Usage”, Jan. 8, 2004). Although more books can be found in digital form, the major publishers continue to distribute and market printed books in more traditional ways.

Other more disruptive technologies such as electronic book readers have been introduced in the last few years. Electronic books (eBooks) are more disruptive because they seek to displace the printed book entirely. Currently, offerings such as eBooks are an inadequate substitute. They rode a wave of hype before disappointing with slow adoption and low sales. In addition to the immediate problems of price (same as printed version) and limited availability of titles, eBook devices are heavy and screens are hard to read. Also, the fragmented nature of the book market may make it difficult for eBooks to become anything more than a niche product. (See C. Zarrow, “E-Pilogue for E-Publishing”, CIO Magazine, Sep. 15, 2002.)

Consumers seem committed to their traditional, tangible relationship with their paper-based printed books.

Paper is a versatile technology that has been perfected over the past 2000 years. It is flexible, durable, cheap, and ubiquitous. Words and images can be stored on it using pens, brushes, crayons, typewriters, or ink-jet printers. It is easy to share. Drop it, fold it, leave it out in the sun or even in the rain, and it still works. Paper works well with its non-digital status-which may explain why technophiles are always gunning to replace it. (See E. Schonfeld, “Paper That Acts Digital”, Business 2.0, at http://www.business2.com/articles/web/print/0,1650,38392,00.htm, Mar. 4, 2002.) What they need is a cost-effective transition for utilizing the imminent new forms of consumer media. A product is needed that addresses these shortcomings by bridging the old (paper) and the new (digital) with both the printed book for its portability and sensory experience and the digital content for its richness and versatility at a reasonable price.

Heretofore, no one has created or assembled the various components contained in the invented enhanced book system offered by Zurimedia, Inc. Nor has anyone applied them to the book publishing industry. Minor aspects of the system exist in digital-only products like eBooks and Acrobat™ PDF files. And those who offer supplementary digital content for books do so inconsistently and in isolation from a broader market approach. None offers the level of sophistication or robust menu of features required to flourish in a normally staid and risk-averse industry. The emergence of supplemental digital printed-book content does however demonstrate that the Internet's impact on the publishing industry is inevitable.

### SUMMARY OF THE INVENTION

The invented system binds the best attributes of two proven mediums, the printed book and the Internet, and creates an improved synthesis employing the unique benefits of both. The flexibility and depth of the Internet is complemented by the tangibility and permanence of the printed book to create a combined superior method of discovery. Specifically, the current invention includes a method and system for publishing electronic multimedia content on the Internet while distributing corresponding printed books. A complete published book provides a concise, static representation of the essentials or subset of the dynamic electronic multimedia content that is possible. The printed book serves as the primary means for access to and navigation of the full electronic multimedia content. Importantly, the printed book need not be re-printed or redistributed for a reader to take advantage of and enjoy the enhanced book-reading experience. Also importantly, publishers need not work too hard to make such an enhanced book-reading experience possible.

### BRIEF DESCRIPTION OF THE DRAWINGS

FIG. 1 is a network topology schematic diagram illustrating access to Internet-based multimedia content via a printed book, in accordance with one embodiment of the invention.

FIG. 2 is an enhanced book access schematic diagram illustrating how a reader accesses the printed book in conjunction with its electronic embodiment.

FIG. 3 is a title content management schematic diagram illustrating how a publisher of an enhanced book prepares the book for printing and prepares the enhanced book for on-line release.

FIG. 4 is an electronic content organization schematic diagram illustrating the hierarchical mapping of an enhanced book for placement of its multimedia contents.

FIG. 5 is an end-user access control diagram illustrating the multimedia contents access login and registration process and pop-up screens for a typical book title.

FIG. 6 is a schematic diagram illustrating a printed book with its identification code affixed therein and a computer-based multimedia contents access page in the background.

FIG. 7 is a page-for-page layout of an open printed book and the corresponding open printed book image on a computer screen illustrating the navigation scheme for both.

FIG. 8 is a schematic diagram illustrating some aspects of the reader (end-user) interface, in accordance with one embodiment of the invention.

FIG. 9 is a schematic diagram illustrating more aspects of the reader (end-user) interface, in accordance with one embodiment of the invention.

FIG. 10 is a schematic diagram illustrating how an administrative user gains access to administration controls, in accordance with one embodiment of the invention.

FIG. 11 is a schematic diagram illustrating some aspects of the administrative user interface, in accordance with a preferred embodiment of the invention.

FIG. 12 is a schematic flow and block diagram illustrating how server request handling occurs, in accordance with one embodiment of the invention.

### DETAIL DESCRIPTION OF THE INVENTION

The invention involves a system, method and apparatus for publishing electronic multimedia contents while providing access thereto also via a printed medium. Printed book herein is intended broadly to mean any bound printed matter or material, bound presumably because it is subject matter or thematically related. The invented method includes a) providing a plurality of multimedia contents divided into discrete topics or titles; b) posting the contents on-line; and c) distributing highly subject matter-correlative printed medium packaged legibly to represent at least the essential nature of the multimedia contents. The printed medium provides the primary means for access to and navigation of the multimedia contents by supplying a common Internet address for authorized users of the same titles or series of titles. The method further includes d) imprinting on or attaching to each printed copy of each title a unique identification code; e) allowing each user accessing the common Internet address to identify the associated title or series of titles and corresponding unique identification code or codes; f) determining which type of access right is associated with each unique identifying code; g) requiring the user to input additional information that demonstrates the user's association with the printed medium; h) verifying that the user is an authorized user by comparing the input code with a database; i) tracking and recording the authorized user's preferences and activities while the user is accessing the multimedia contents; j) providing a web page or similar electronic location that presents all current and previously authorized title subscriptions for the user; k) in response to selection of any one of the authorized titles, displaying web page or similar electronic location containing facsimile (e.g. word-for-word; page-for-page) content matching that from the printed medium; l) providing at least some independent navigation of the on-line contents, assuming the user has, in hand, the printed medium as the primary directory and guide for navigating the on-line contents; and m) displaying links from within the area representing the matching printed medium contents in the display margins surrounding the printed medium contents or from separate menus to fully complement the printed medium contents with information and/or multimedia supplemental to what is contained within the printed medium itself. The tracking and recording of authorized user preferences and activities permit data compilation among a wide number of authorized users and conveyance of such compiled data for after-market syndication or promotional opportunities.

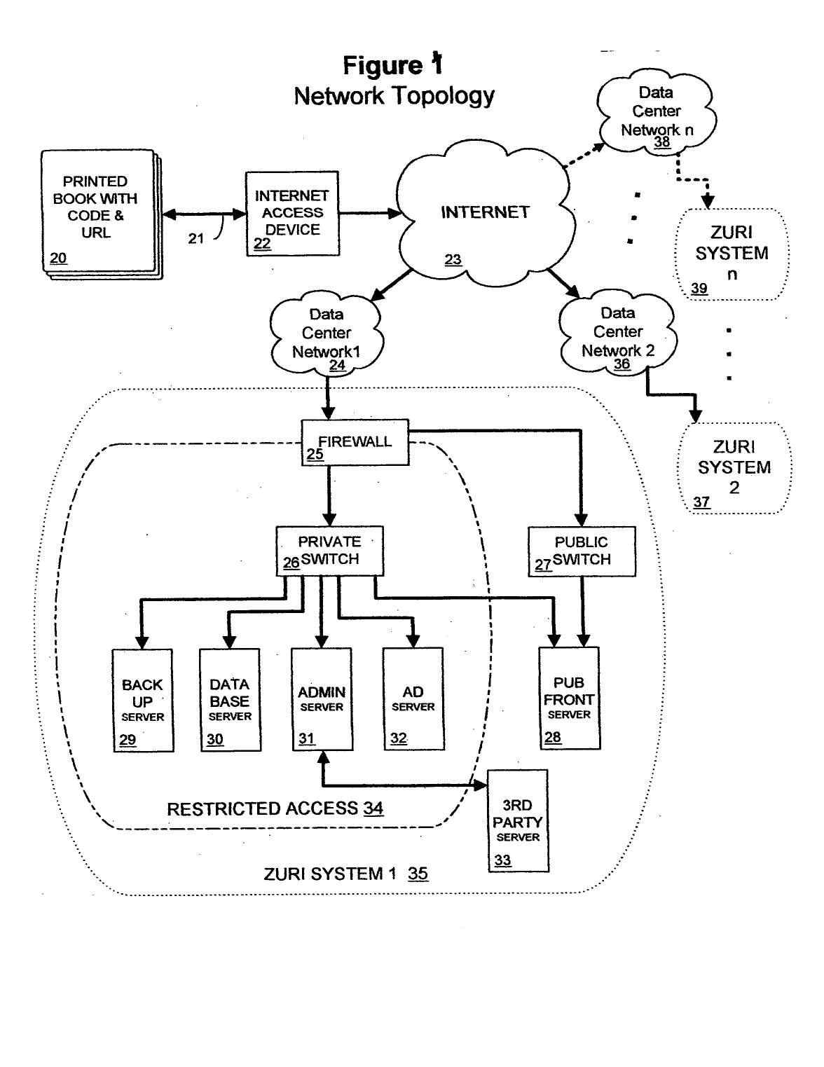

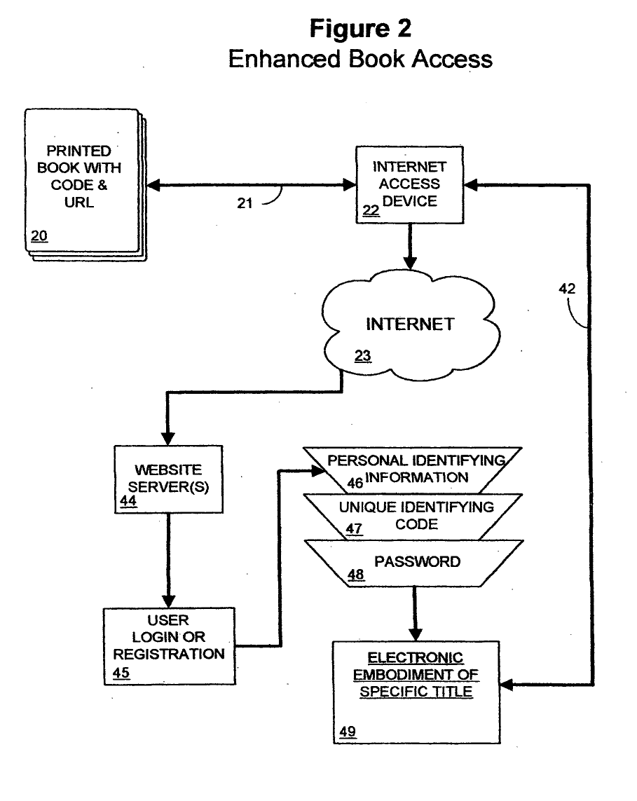

A network topology representing a system, method and apparatus for access to and navigation of an electronic multimedia information system via a printed medium, e.g. a book, is illustrated in FIGS. 1 and 2. First, a user purchases a printed book 20 with a unique title code and a URL that enables user interaction 21 with an Internet access device 22 to gain access through the Internet 23 to the associated on-line electronic multimedia content. Thus, even if a user is aware that printed book 20 is an enhanced book having associated on-line electronic multimedia content, nevertheless access to such multimedia content on Internet 23 begins with the printed book 20.

The interaction 21 between the printed book 20 and an Internet access device 22 is initially one-way, wherein the code and URL associated with printed book 20 represents linking information to a website portal such as a data center network 1 indicated in FIG. 1 at 24. Data center network 24 is operatively connected to what will be referred to herein as a Zuri™ system 35 such as Zuri™ system 1.

Zuri™ system 1, which is typical of any of plural such Zuri™ systems 1-n, in accordance with one embodiment of the invention, includes a firewall 25 to permit restricted access via a private switch 26 to private, so-called back-office Zuri™ system resources to be described. Firewall 25 permits public access to certain public, so-called front-office system resources including a public switch 27 and a Public Front server 28.

Private switch 26 obtains access to back-office Zuri™ system resources including a back-up server 29, a database server 30, an administrative server 31, an advertising server 32 and a 3^{rd} party server 33. Those of skill in the art will appreciate that a 3^{rd} party provider may have its own access protocol. Thus, illustrating 3^{rd} party server 33 in the system block diagram simply illustrates that eth invented system may employ or utilize or license services provided by 3^{rd} party providers. The 3^{rd} party provider would have an application or database that the Zuri™ system could access via administrative server 31. Thus, while 3^{rd} party server 33 is shown as being outside restricted access zone 34, it will be appreciated that access thereto typically would be controlled by the 3^{rd} party provider's access protocol.

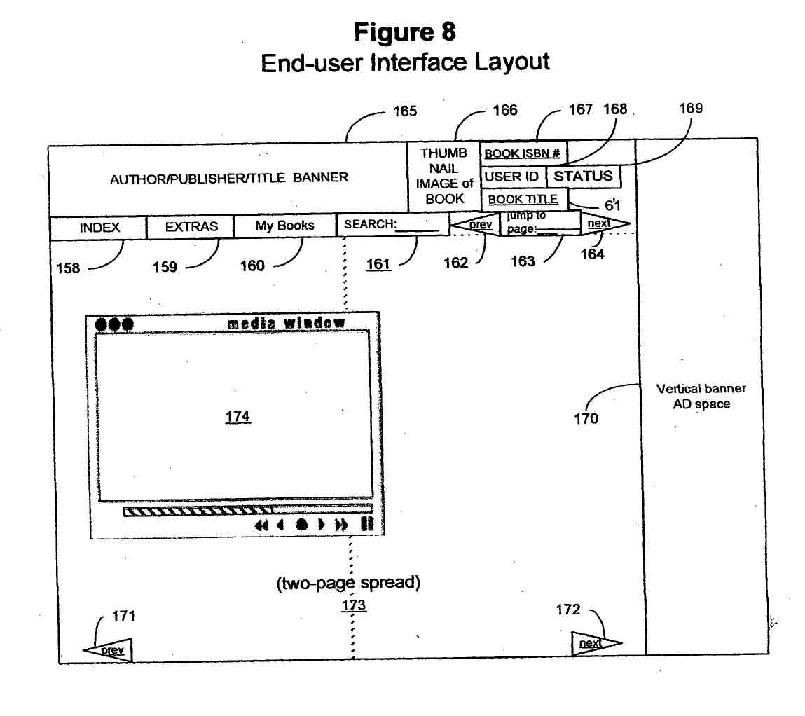

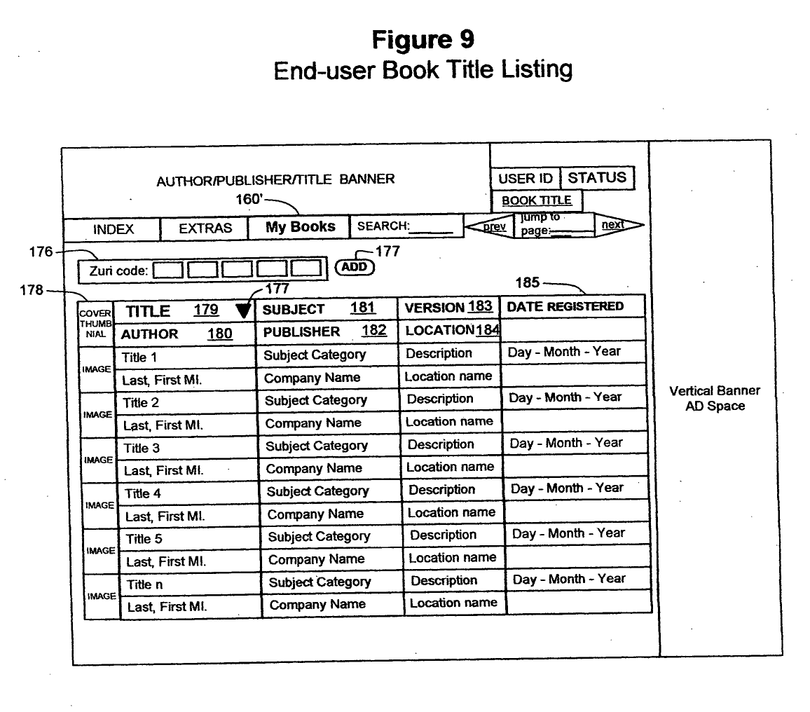

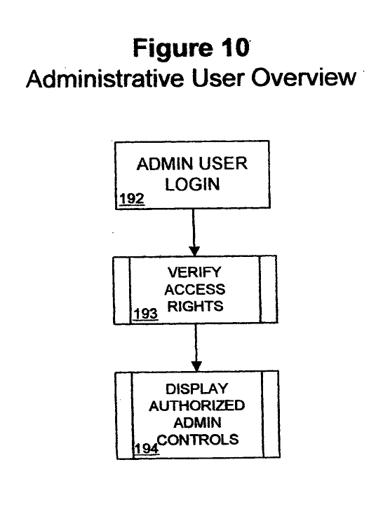

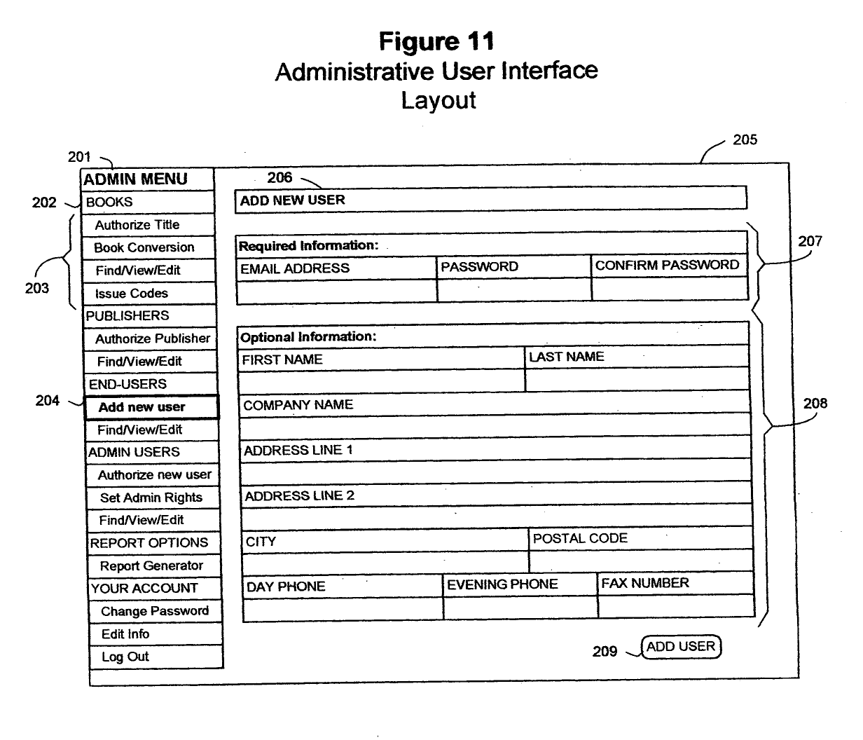

Those of skill in the art will appreciate that private switch 26 provides access by data center network 1 via firewall 25 to any one of database server 30 (which can be a digital content server), backup server 29 (which is optional but may be needed depending upon bandwidth demand), administrative server 31 (the purpose and function of which will be described in detail below by reference to FIGS. 10-11), advertising server 32 (which provides advertising and marketing links in the margins of the user interface screens to be described in detail below by reference to FIGS. 8-9) and Public Front or facing server 28 (which serves up all of the consumer content).

From FIG. 1, those of skill in the art will appreciate that n supplemental data center networks 36, 38 may be included in the system to provide virtually unlimited back-up and/or redundancy, as illustrated. Each supplemental data center network, e.g. networks 2-n, is operatively connected to a corresponding supplemental Zuri™ system, e.g. Zuri™ system 2-n.

It will be appreciated that the network topology shown in FIG. 1 enables an end-user having printed book 20 in hand to access enhanced book features residing in a secure cabinet 33 via the Internet, using a personal computer (PC). In accordance with the invention, an electronic facsimile embodiment of any specific printed book title may be accessed by a registered end-user by simply going to a predefined URL, identifying him or herself and entering a unique identification code for the printed book. The enhanced book features typically include digital content that are developed and maintained to supplement the printed book. Redundant data center networks, a firewall, a public and a private switch control the end-user's access to database, backup and advertising servers that are maintained by an administrative user, enabling publishers and authors of printed books to keep the printed book current as well as interesting.

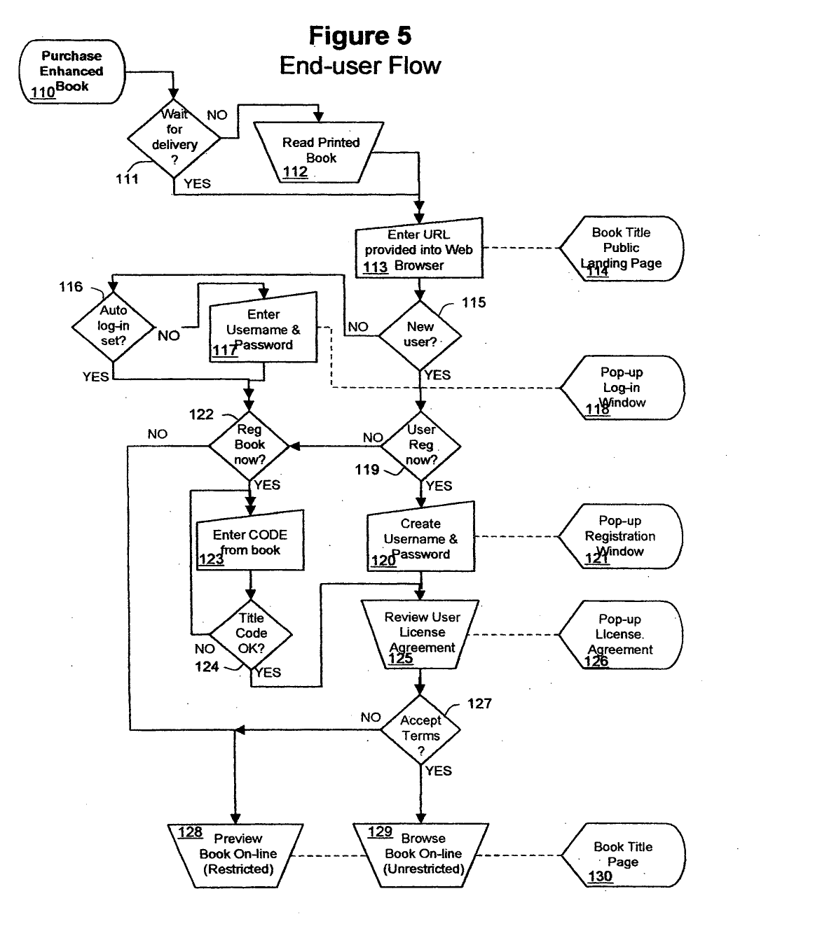

FIG. 2 is a simplified schematic diagram illustrating how a user who is a typical reader accesses the enhanced book resources that form a part of the invented system. Those of skill in the art will appreciate that FIG. 2 features the reader's perspective, for whom the internal workings of data center network 24 and Zuri™ system 35 are virtually transparent or invisible. In other words, a typical enhanced book reader need not understand such system architectures; he or she need understand only the basics of straightforward Internet access and logon procedures. Those of skill in the art will also appreciate that navigating the enhanced book and its correlative multimedia resources also involves a straightforward user interface that will be described below by reference to FIG. 5.

Brief reference to FIG. 2 aids in understanding enhanced book access as it fits into the network topology of FIG. 1. Enhanced book access will be described in more detail below by reference to FIGS. 5, 6a-6c, 7a-7c, 8 and 9.

FIG. 2 illustrates how a user accesses an enhanced book, in accordance with one embodiment of the invention, by entering visible indicia borne by a hardcopy of printed book. The visible indicia preferably include a unique identifying code, e.g. an accession code, and linking information, e.g. a URL, associated with printed book 20. Access typically is via interface 21, Internet access device 22 and Internet 23, identically depicted in FIG. 1. Internet 23 gives the reader access to one or more website servers 44, each of which invite the user to login and register his or her enhanced book purchase. Thus, user login or registration 45 typically requires the user to enter personal identifying information at 46, a unique identifying code or accession code at 47 and a password at 48 before the user at gains access to the otherwise restricted electronic embodiment of the specific title 49 that corresponds with printed book 20.

Those of skill in the art will appreciate that block 49 contains the restricted resources that are available via controlled access by a reader or end-user. The bidirectional control line 21 represents the interactive nature of the on-line exploration by an end-user of the on-line electronic contents of printed book 20. In other words, reading an enhanced book is not a passive undertaking like watching television or even reading a traditional printed book. Instead, the end-user of the invented system is actively making requests, clicking buttons, changing pages, etc. and observing results.

As will be seen in more detail below by reference to FIG. 5, access by an end-user is controlled by identification and login (or a downloaded cookie for a former end-user who already has registered), which effectively renders restricted electronic embodiment 44 ‘readable’ by the end-user along with printed book 20. Those of skill in the art will appreciate that restricted electronic embodiment 49 in accordance with the invention can reside on a server that is authenticated and monitored by the Zuri™ server but housed and maintained by a publisher.

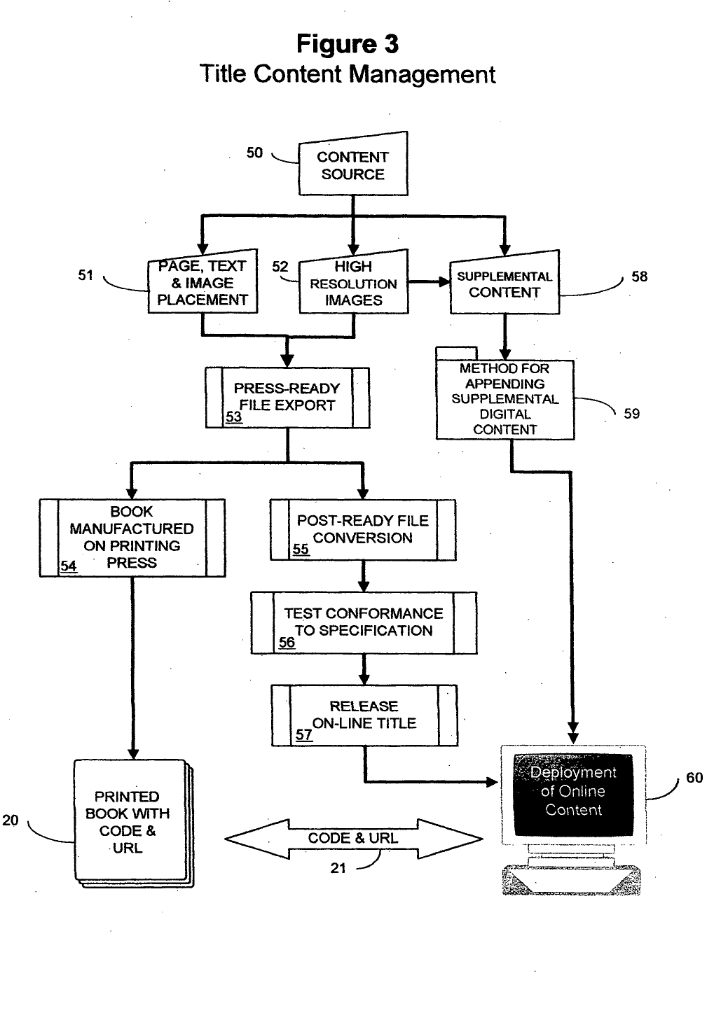

Title content management is illustrated in FIG. 3, from the perspective of a publisher or author-publisher who desires to provide an enhanced printed book 20. Such title content management typically would be licensed under the invention and thus would be available only to licensees of the present invention.

Title content management is based in the availability or creation of content source 50, which can be an existing printed book 20 or a new enhanced book title having correlative electronic, e.g. multimedia, content. In other words, content source 50 as illustrated in FIG. 3 represents prospective enhanced book content source material.

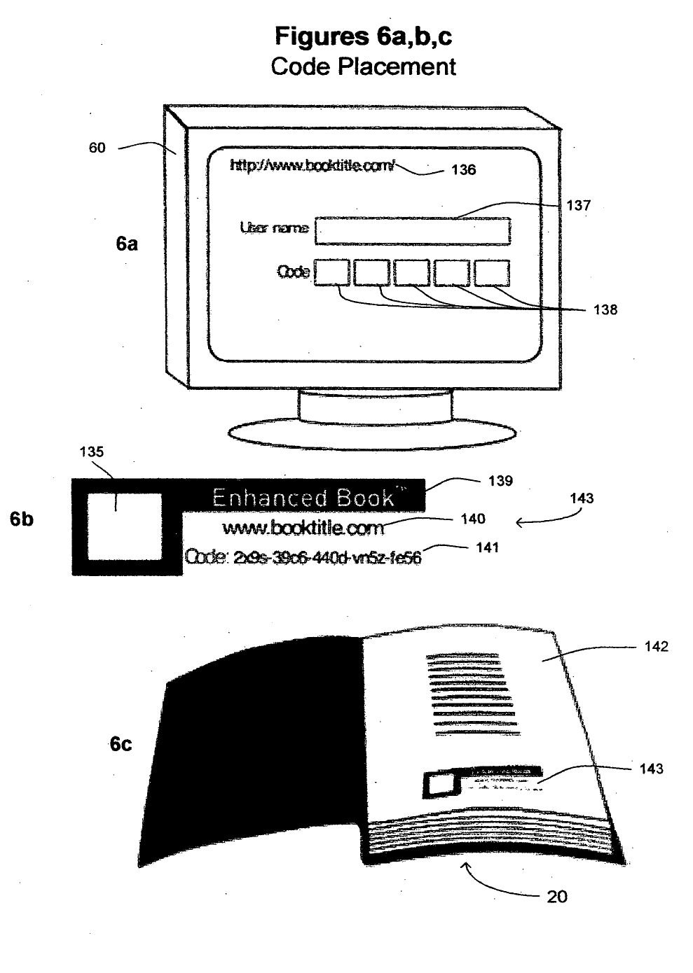

Thus, enhanced-book title content management includes identifying content source 50 having multimedia components including one or more of page, text and image placement features 51 and high-resolution images 52. Such content source materials are, in accordance with one embodiment of the invention, fed to a press-ready file export mechanism 53, which enables export of printed material for printing press book manufacture 54 and post-ready file conversion 55. The output of book manufactured on printing press mechanism 54 is a printed book 20 with associated code and URL to be described below by reference to FIGS. 6a-6c.

The output of post-ready file conversion 55 is sent through test conformance to specification 56, which permits the enhanced book publisher to assure the quality of the enhanced book content and features. The output of the test process 56 is a release process that places the enhanced book title with its enhanced electronic multimedia features on-line. Supplemental content 58—that may include high-resolution images 52 among other multimedia file types—may be added to content source 50, via a method for appending supplement digital content 59 prior to deployment of the on-line content.

Deployment of the on-line content typically is accomplished at the same time the printed title is released while any appended supplemental digital content can be added on an ongoing basis. It is thus available to registered users, e.g. authorized readers of the enhanced book on a personal computer (PC) or like device 60 when they purchase the book. Those of skill in the art will appreciate that the registered user code and URL conveyance 21 are used by the reader of printed book 20 during logon and registration of the enhanced book title to access the on-line electronic, e.g. multimedia resources. This logon and registration process will be described in detail below by reference to FIG. 5.

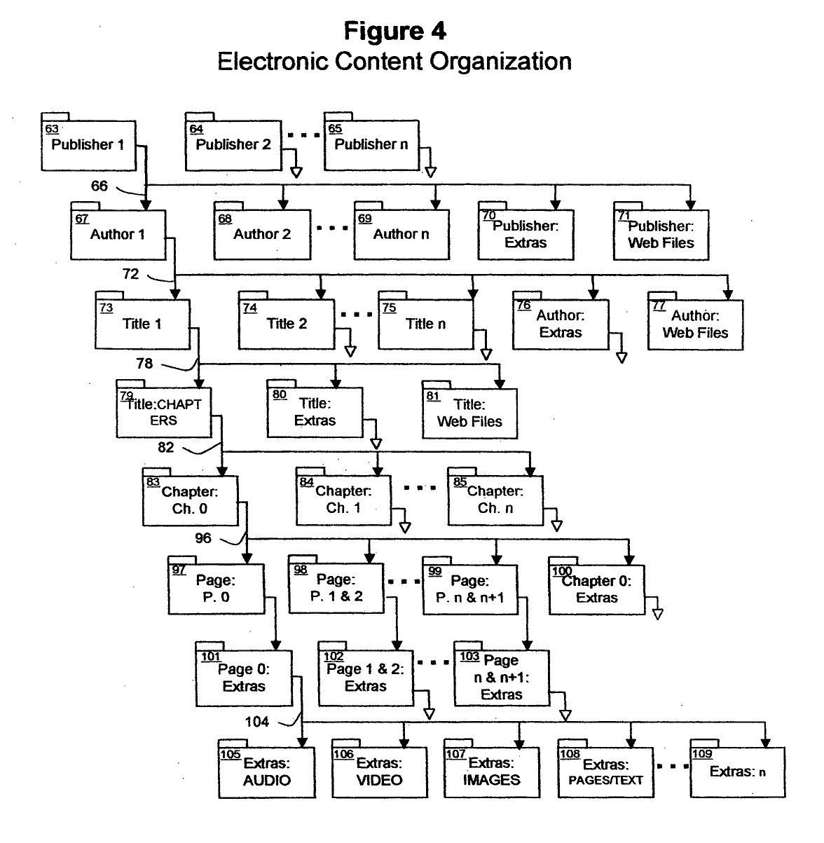

Turning now to FIG. 4, the electronic content deployed in FIG. 3 is illustrated from an organizational standpoint. Those of skill in the art will appreciate that the organization is hierarchical, having multiple levels, which permits logical access to others. This organization may be virtual, with the actual placement of files organized according to a give database structure, while the apparent organization remains hierarchical. For example, access to data regarding publishers 1 and 2-n (63 and 64-65) at level 1 (66) provides access to a corresponding set of authors 1 and 2-n (67 and 68-69) that relate to each publisher, as well as to corresponding publisher extras 70 and publisher web files 71 at level 2 (72). Similarly, access to authors 1 and 2-n provides access to a corresponding set of titles 1 and 2-n (73 and 74-75) that relate to each author, as well as to corresponding author extras (76) and author web files (77) at level 3 (78).

Similarly, access to titles 1 and 2-n provides access to a corresponding set of title chapters (79) that relate to each title, as well as to title extras (80) and title web files (81) at level 4 (82). Similarly, access to title chapters (79) provides access to a corresponding set of chapters 0 and 1-n (83 and 84-85) at level 5 (96). Similarly, access to chapter 0 (83) provides access to pages 0 and ½−n/n+1 (97 and 98-99) that relate to this chapter, as well as to chapter extras (100) that relate to this chapter. Similarly, access to pages (97-99) provides access to corresponding page extras (101-103) that relate to each page at level 104. Finally, at level 7 (104), access to pages (101-103) provides access to a corresponding set of extras including audio, video, images, pages/text and others (105-109) at the next level.

Those of skill in the art will appreciate that the hierarchical organization simplifies updates by publishers or administrative users of the invented system. For example, adding supplements to an existing title need not affect all titles in a series or all titles by a given author and so can be accomplished using the title index or level 2 (72). Conversely, adding supplements to all titles of a given author or publisher need be done but once by using the author or publisher levels 1 or 2 (66 or 72), respectively, to supplement all such titles.

Use of folders in an administrative user interface greatly facilitates updates or supplements to the electronic contents of a printed book. Thus, in accordance with one embodiment of the invention, supplementing or updating electronic content of an enhanced book is as easy as clicking on and dragging and dropping the supplement onto one of the folder icons within a folder hierarchy chart presented in an administrative user interface screen. Those of skill in the art will appreciate that alternative methods of editing, supplementing or updating the electronic contents are contemplated and are within the spirit and scope of the invention.

Referring now to FIG. 5, a more detailed access control flowchart for the end-user will be described. First, the end user purchases an enhanced book at block 110. If the printed book part of the enhanced book purchase is available, then no wait for delivery is required at block 111 and the end user can proceed to read the printed book 20 at block 112. If the printed book part of the enhanced book purchase is not available, the end user must be provided an access code by the book supplier or the end-user must await the printed book's delivery. Upon delivery, the end user reads (all or part of) the printed book 20 at block 112.

At block 113, the end user familiar now with the print contents of printed book 20 desires to explore the enhanced book content and features. Accordingly, at block 113, the end user enters linking information, e.g. the URL provided with printed book 20, into a browser of world-wide web or Internet 23. At block 114, the end user's computer screen displays a book title public landing page returned by the browser and based upon the URL the end-user has entered.

Referring still to FIG. 5, if it is determined at block 15 that the user is not a new user, then via block 116, the established end user is logged in either automatically or manually at block 119 via a pop-up log-in window 120. If it is determined at block 115 that the user is not a new user, and that the end-user's auto log-in is not set, as determined at block 116, then at block 117 the end-user enters personal information, e.g. his or her username, and password to register him or herself via pop-up log-in window 118. (This is of course but one embodiment of the invention. Other display/interface means are within the spirit and scope of the invention.) If instead the user is new and wishes to register him or herself now, as determined at block 119, then at block 120 the end-user creates a username and password via pop-up registration window 121.

At block 122, it is determined whether the end-user wishes to register the book now, so as to obtain unrestricted access. If so, then he or she enters the unique identification code from the book at block 123. Assuming the title code was entered correctly, as determined at block 124, the end-user at block 125 reviews and approves the title license agreement via pop-up license agreement window 126. If the end-user refuses to accept such terms, as determined at block 127, then the end-user is permitted only a preview of the on-line book at block 128 via a book title page. (This same preview is available to an end-user who refuses to register the new book title, as may be seen from FIG. 5 at block 122).

If instead the end-user accepts the title license terms, then he or she is permitted unrestricted browsing of the on-line book at block 129, via book title page pop-up window 130. The end-user interface and book title page 130 will be described in detail below by reference to FIG. 9.

In accordance with one embodiment of the invention, Zuri™ system 35 directs the user to the area representing highly subject matter-correlative on-line multimedia contents, or electronic embodiment, 49. As an alternative, however, the user may be first directed to an intermediate location such as a portal website or Internet access device 22 via interface or conveyance 21 (refer to FIG. 1).

Referring now collectively to FIGS. 6a-6c, the mechanism for relating a physical printed book 20 and corresponding digital, e.g. multimedia, resources will be described. Printed book 20 (FIG. 6c) includes an inside page 142 that, in accordance with one embodiment of the invention, contains a legible printed label 143 (6b) bearing certain unique indicia. The indicia on label 143 include a brand placed, in one embodiment, at 135, an Enhanced Book tag 139, a Uniform Resource Locator (URL) 140 and a unique identifying code 141 comprising five fields of four alphanumeric digits each.

Those of skill in the art will appreciate that, when login is completed, and the user is determined to be an authorized user, the authorized user is granted access to the restricted (i.e. access-controlled) on-line multimedia information. The multimedia contents can be accessed directly or indirectly through any suitably secure file storage means including a networked server or a distributed peer-to-peer file system, as are known.

Referring now to FIG. 6a, a first-time visitor attempting to log in at user login or registration block 45 of FIG. 2 will be required to enter URL 141 read from label 143; his or her personal identification information, e.g. a user name, 137; and the printed book's unique identification code 141 in five fields 138 of four alphanumeric digits each. Those of skill in the art will appreciate that label 143 may be affixed to any inside page or to the cover or inside of the cover or to the binding of printed book 20. Thus, alternative placements of label 143 are contemplated and are within the spirit and scope of the invention.

Thus FIGS. 6a-6c may be understood by those of skill in the art to represent the relationship between the physical printed book and the digital enhancements that are correlated therewith as a part of creating and using an enhanced book. Unlike prior art attempts to digitally enhance printed books, which have been notoriously unsuccessful, Zuri™ system 35 and its associated network architecture avoids the need for publishing a new edition of a book every time its electronic content changes. This is because the invented system avoids prior art pitfalls that require subliminal or legible embedding of codes or markers in the text or margins of a printed book, the embedded markers being readable by an optoelectronic device like a hand-held wand.

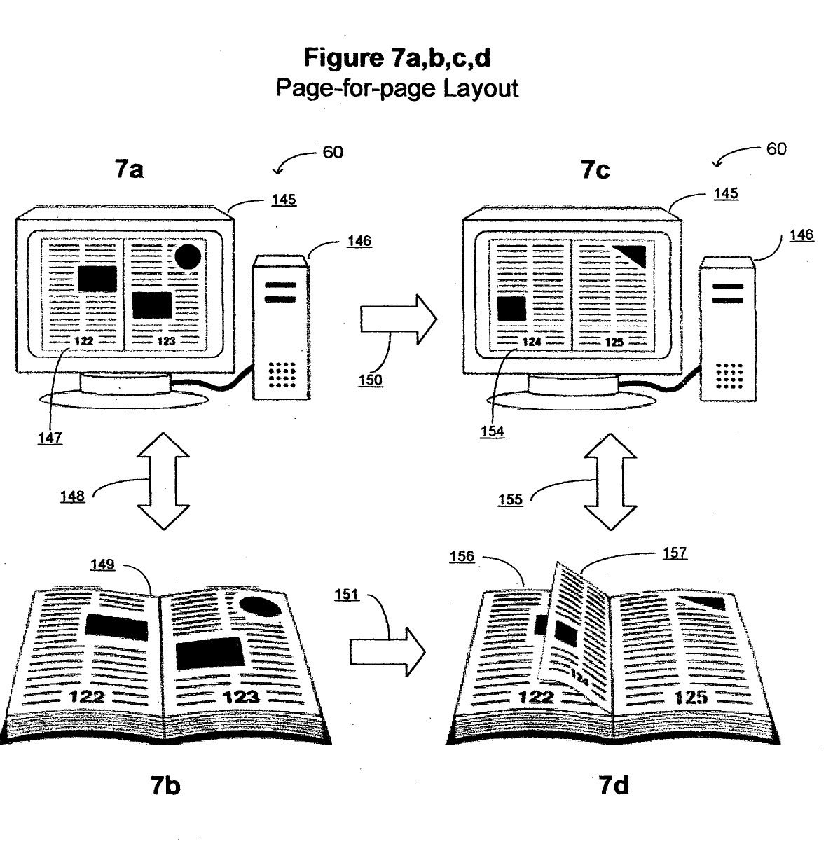

As illustrated in FIGS. 6a-c, the printed book with its cover opened reveals both the content location pointer or URL 140 and the unique identification code 141 to access the on-line multimedia content associated with printed book 20. Those of skill in the art will appreciate that the combination of the URL and the identification code permit an authorized end-user (reader) to access all of electronic resources associated with printed book 20 via computer 60 and the use thereon of a facile end-user interface to be described below by reference to FIGS. 7a-7d and 8-9.

In contrast, the electronic content part of the invented system is continuously updatable without impact on the printed book to which it relates. Moreover, publishers need not embed anything within the text of the printed book in order to take advantage of the present invention. Indeed, the only impact on the printed book itself is labeling it as such with the unique identification code that points to the enhanced electronic features. Thus, a printed book already in circulation can be retrofitted with enhancements, opening the entire printed-book world to electronic enhancements.

Requiring entry of a user's personal identification information 46 is believed to ensure that only authorized users take advantage of the invention. This feature of the invention ensures that only authorized users access the enhanced book resources. Nevertheless, authorized users could access resources associated with printed books that have not been purchased by the otherwise authorized user. Thus, further security against piracy or theft or other unauthorized access to the on-line enhanced book resources may be provided, as may be deemed necessary, in accordance with the invention, as will be described below.

For example, further security may be provided by the invention that substantially prevents use of the digital resources unless there has been a corresponding printed-book purchase. This protects authors and publishers from intellectual property (IP) piracy.

A thief who might go to a bookstore and memorize or copy the identification code from a printed enhanced book to gain unauthorized access to the invention's digital resources (which could include a digital copy of a printed book) should be stymied. Thus, in accordance with one embodiment of the invention, a theft prevention feature requires a user during the log-on procedure correctly to answer one or a series of questions (the correct answers to which only an authorized user would likely know).

For example, a user who enters a proper, and apparently authorized identification code, may be asked a series of questions that would be unknown to one who, by merely memorizing or transcribing the identification code from a printed book as opposed to purchasing the printed book, attempts to steal the benefits of the enhanced-book invention. The questions would be easily answered by one who has the printed book, but would be nearly impossible to answer by one who does not.

Such questions could relate to series of randomly located words in the printed book, e.g. the third word in the second line on page 23 thereof. Such random key word locations could be established by the publisher of the printed book. The selection of the key words may also be automated in one embodiment. By asking a series of multiple ones of such questions, and by requiring all correct answers during the log on process, an unauthorized user would be prevented access.

Alternative security means of course are within the spirit and scope of the invention. Point of sale terminals may assign the random location codes that are associated with a given printed book. This would prevent loss of revenue due to piracy even in the after-market resale of printed books that have enhanced resources associated therewith.

FIGS. 7b and 7d illustrate a printed book lying open to facing pages 122 and 123 (FIG. 7b) with the page being turned to expose facing pages 124 and 125 (FIG. 7d). FIGS. 7a and 7c illustrate the on-line facsimile of printed book 20 at 147 and 154, respectively, corresponding with the printed book shown in FIGS. 7b and 7d.

The relationship between the printed book image 149 on pages 122 and 123 and the on-line book image 147 on display screen 145 is indicated by an arrow 148. The relationship between the printed book images 156, 157 on turned pages 124 and 125 and the on-line book image 154 on display screen 152 is indicated by an arrow 155. The relationship between the previous facing page printed book image 149 and the next facing page printed book images 156, 157 is indicated by an arrow 151. Finally, the relationship between the previous on-line page image 147 and the next on-line page image 154 is indicated by an arrow 150. Those of skill in the art will appreciate that the display images appear on a display screen or monitor 145 operatively connected with an end-user's (reader's) desktop personal computer (PC) tower 146. Those of skill in the art will appreciate that monitor 145 and tower 146 are indicated generally in FIGS. 7a and 7c as 60′. (The end-user's PC of course may take any suitable form, whether an integral workstation 60 as in FIG. 3 or separate monitor/tower 60′ as in FIGS. 7a and 7c. It also may take the form of a laptop, PDA or smart mobile phone, not shown.)

The two-page spread on the computer's display screen, described above and illustrated in FIGS. 7a-c will be understood to include individual page images scaled to a desired size and presented in any desirable font or color scheme to closely resemble printed book 20 in form (including pagination) and contents (whether textual or graphical or freeform) while facilitating navigation of available multimedia resources that relate to the open pages of the printed book. These images serve as page-relational entry points to the multimedia contents and are one embodiment of a variety of possible ways to provide parametric access to the on-line contents, as will be discussed further below.

In accordance with one preferred embodiment of the invention, location pointer 136 takes the form of a URL such as www.book-title.com, www.publisher.com/book-title, www.enhancedbooks.com/publisher/book-tide, www.enhancedbooks.com or www.zuribooks.com. Those of skill in the art will appreciate that alternative approaches to pointing a printed book reader to the location on line of enhanced-book resources such as multimedia or other electronic contents are contemplated and are within the spirit and scope of the invention. Also in accordance with one preferred embodiment of the invention, unique identification code 141 takes the form of what will be referred to herein as a Zuri™ number. A Zuri™ number concatenates five groups of four alphanumeric or special symbols each (if alphabetic, then preferably lower-case unless easily misread), e.g. 8hfu-L1jv-7zoi-i201-mnpq. Again, those of skill in the art will appreciate that any suitably secure unique identification code is contemplated as being within the spirit and scope of the invention.

To briefly summarize the relationship between the printed book and the associated on-line multimedia contents, the printed book may be thought of as a guide to navigating the corresponding electronic contents. This relationship is that the user first reviews the content of the printed book then, upon settling on a specific page of the book views the corresponding facsimile on-line contents by inputting the same page number into the computer device. A computer screen shows a 2-page spread image of the chosen pages that corresponds to the chosen pages of printed book 20. When the user turns a page in printed book 20 to see new contents, the user can also use any number of computer input devices or methods to cause the corresponding on-line contents representative of and supplementary to that of the chosen printed book pages to be displayed also on the computer screen.

Upon successful registration or log-in, the user wishing to view the on-line multimedia contents is presented with computer screen organizations like those of FIGS. 8-9 to be described in detail below. The end-user interface, with its pull-down and/or pop-up menus and buttons or tabs, facilitates login and registration of end-user and printed book and also facilitates navigation into and around the on-line contents of one or more book titles. Those of skill in the art will appreciate that alternative computer screen organizations and navigational mechanisms for end-users (and also for administrative users and publishers) are contemplated as being within the spirit and scope of the invention.

Another feature of the invention in one embodiment involves awarding so-called Zuri™ points to an end-user during logon, registration or on-line sessions. Zuri™ points, for example, are earned and awarded incrementally, or progressively, as the end-user enters more information into the Zuri™ system end-user database that is a part of database server 30. If the end-user enters his or her name, then one or more Zuri™ points are awarded. If the end-user enters his or her home address, then one or more Zuri™ points are awarded. If the end-user enters his or her e-mail address, then one or more Zuri™ points are awarded. Etcetera. Zuri™ points may be redeemed by the end-user in accordance with a defined reward system leading to a greater sense of affinity for the end-user towards the Zuri™ system, e.g. a free enhanced book subscription or voucher is credited to the end-user's account or mailed or e-mailed to the end-user. Those of skill in the art will appreciate that Zuri™ points also may be rewarded for particular reader activities other than demographic or geographic data entry. For example, an end-user previews three books by one publisher. A reward might be points permitting the end-user to purchase one of them at a discount. Or an end-user buys two books from an author. A reward might be points to allocate towards a discount on another book purchased at a later time from the same author. Thus, Zuri™ points may also reward end-user activities unrelated to end-user registration.

Such an incremental or progressive on-line reward system garners valuable demographic and geographic data on the end-users of Zuri™ system 35. Such data are valuable to the Zuri™ system provider, to the publisher and to advertisers who use the Zuri™ system to push marketing and promotional links, brands, services and products.

Another feature of the invention will be referred to herein as temporal versioning. In the educational world, e.g. K-12, community colleges and universities, there is often a need to supplement a textbook for a limited time and to make such a supplement available to registered students in a given class. Those of skill will appreciate that temporal versioning is useful regardless whether a student's ‘classroom’ setting is in-person or on-line.

A professor might wish to provide a unique version or view of the enhanced textbook in accordance with the present invention, wherein students have the benefits of a printed textbook and also on-line electronic enhancements thereto such as multimedia contents and/or links to supplemental articles and/or resources that they instructor deems specifically relevant. Temporal versioning in this context refers then to maintaining and updating the on-line enhancements for some end-users of the textbook during a given school term to keep the teaching material rife and fresh. When students of that professor register their book, they will, as an additional step, specify their preference to see that specific professor's unique version. Other professors may be doing their own unique on-line version of the same book title for a separate class.

FIG. 8 illustrates an end-user interface layout that forms a part of the invention in one embodiment. The end-user interface features a current book title 6, an index 158, an extras 159, a my books 160, a search window 161, a page-turn cursor control mechanism including a previous-page button 162, a jump-to-page button 163 and a next-page button 16, a thumbnail book image 1664. The interface further features an author/publisher/title banner 165, a thumbnail book image 166, a book ISBN # 167, a user I) 168 and a status 169.

A vertical banner advertiser space 170 is provided, which may have single or multiple advertising links and associated branding. The largest section of the end-user interface is dedicated to a facsimile image of the printed book, identified in FIG. 8 as a 2-page spread and a vertical page divider (dotted line). Page numbers for the 2-page spread are featured at 173 to identify which page of the digital facsimile of printed book 20 the end-user is viewing at any given time. The end-user interface features a redundant previous-page button 171 and a redundant next-page button 172 to facilitate page turning. Finally, a media player pop-up window 174 is provided to facilitate viewing of multimedia resources or playing musical tracks, etc. as part of the enhanced book experience.

Those of skill in the art will appreciate that any suitable end-user interface is contemplated, including those with quite different layouts or feature sets. Thus, alternate window layouts and more or fewer features and/or functions differently arranged nevertheless are within the spirit and scope of the invention.

In brief summary, by the use of standard web user interface design techniques, access to multimedia contents may leverage the use of pop-up and/or drop-down menus and standard media players to display or activate various forms of the multimedia contents. FIG. 8 thus will be understood schematically to show in the display screen image of a computer the static image that relates, as described and illustrated above with respect to FIGS. 7a and 7c, to printed book 20 and its correlative multimedia contents. Static elements such as text and images that appear in the printed book can contain additional functionality in its on-line form in additional to the facsimile page images. For example, one preferred embodiment includes selected embedded links to additional pages or supplemental multimedia contents. In accordance with one embodiment of the invention, such links are accessed via pull-down and pop-up menus, as illustrated, without entirely obscuring the facsimile page images.

Thus, a printed non-fiction book on the history of boxing, for example, may be supplemented and greatly enhanced by providing to authorized users access to a library of multimedia resources including boxing video and/or instruction viewable on-line using a media player within a pop-up window of clickable menu entries. Similarly, in accordance with the invention, the printed book on boxing may be enhanced by providing users access to other related on-line materials including text, audio, video, etc. accessible in a pull-down window of clickable menu entries. Or a printed fiction book featuring a character who is a fly fisherman may be supplemented and greatly enhanced by providing access to a library of multimedia resources including angling view or scenery viewable on-line using such a media player. Or a printed textbook on genetic engineering may be updated and/or enriched in real-time with developments in the rapidly changing field by providing a student access to such materials in the real-time, highly correlative, linked and intuitive manner described herein in accordance with the invention. The set of integrated tools for end-users, administrative users, publishers and others make enhanced books readily available to anyone who desires to augment the contents of new or existing printed books.

Those of skill in the art will appreciate that there can be content surrounding the illustrated window that might relate remotely or proximately to the use of the present invention. For example, use of these header and margin by a publisher or a third party to the enhanced book provider might advertise related products and services. Or the header and margin may be used by the enhanced book provider itself to provide related information via link or pop-up advertisement to, for example, an associated contents provider or bookseller or publisher or author or title. Thus the header and margin may be as specific as desired to product, promotion, brand and logo of the provider (e.g. Zurimedia Inc.), the publisher (e.g. Harcourt Brace), the wholesaler/retailer (e.g. Amazon, Wal-Mart), the bookseller (e.g. Powell's Books), etc.

In accordance with the invention, a title need not be revised or updated in order to bring it within the enhanced book umbrella. This is because the invention does not rely, as do prior art approaches, on embedding—within the text, graphics or margins of a printed book—subliminal codes to be read by optoelectronic scanners. The invention relies instead on a bold, legible URL and a bold, legible, unique identification code provided with the printed book or affixed on label inside its cover or printed therein upon original printing as an enhanced book title. Thus, the text, graphics and margins of the pages of a printed book are completely unaffected by the printed book's digital enhancement in accordance with the invention.

FIG. 9 is an end-user book title listing window illustrating how the end-user interface works. The end-user has clicked on the My Books button 160, which selection is highlighted in boldface text on the display screen and indicated now as 160′. (Those of skill will appreciate that, had the end-user simply positioned the cursor over highlighted My Books button 160′ without also clicking it, a pop-up menu of titles would have appeared at reduced scale.) The result of this selection is that the end-user's enhanced book title list is displayed on the large are of the window so that all can be viewed, as by scrolling through the list. (Those of skill in the art will appreciate that this is similar to on-line browsing, using any suitable cursor control, not shown, in FIG. 9 for the sake of clarity.) A window displaying a chosen title's Zuri™ code pops up at 176, along with an Add button 177 for adding titles to My Books. A cover thumbnail image of each title is displayed in column 178. A Title and Author column, a Subject and Publisher column, a Version and Location column and a Date Registered column are displayed, as shown. Those of skill in the art will appreciate that any that a variety of additional sources of data may be available and displayed for other embodiments of the invention.

If the end-user clicks on Add button 177, a new title pops up into the list according to the chosen list sorting rules (e.g. by Title). Title 179, Author 180, Subject 181, Publisher 182, Version 183, Location 184 and Date Registered 185 are all filled in by the Zuri™ system 35.

The remaining regions of the window are as described above. Other button selections function similarly, thereby to provide a robust end-user interface that enables quick and easy navigation not only of the enhanced book facsimile image, e.g. page turning, but also of the many features of the Zuri™ system itself

FIG. 10 is a simplified, administrative user overview process flow diagram illustrating how administration proceeds in accordance with one embodiment of the invention. The administrative user logs in at block 192 in a manner that is similar to login by an end-user, as described in detail above. The administrative user's access rights are verified at block 193 to ensure that the proper access control level is not exceeded, i.e. to ensure that the administrative user's access does not exceed his or her authority. Finally, at block 194, a display screen is opened on the administrative user's computer that displays the authorized administrative control interface and query/command buttons enabling the administrative user to navigate through the administrative functions involved in authorizing, converting and supplementing printed book 120 with electronic enhancements.

FIG. 11 is an administrative user interface layout window illustrating how the administrative user interface facilitates administrative functions. The interface in accordance with one embodiment of the invention includes an administrative menu 201, which is highlighted in FIG. 11 and its various menu entries, including capital letter major headings such as BOOKS 202. Under the BOOKS heading, various buttons represent various self-explanatory administrative functions including Authorize Title, Book Conversion, Find/View/Edit (a title) and Issue Codes. At block 204, it may be seen that, under the END-USERS heading, Add new user is highlighted, indicating that it has been selected by the administrative user.

Selecting (e.g. by clicking on) Add new user button 204 invokes the right two thirds of the screen, indicated generally at 205, which pertains thereto. At block 206, the ADD NEW USER banner is visible, and, therebeneath, a Required Information field 207 and, therebeneath, an Optional Information field 208. It may be seen that Required information field 207 permits entry by the administrative user of EMAIL ADDRESS, PASSWORD and CONFIRM PASSWORD fields for the new user. Optional Information field 208 may be seen to include further new user information fields including name, affiliation, address, phone number, etc. A button 209 labeled ADD USER, when selected, e.g. by clicking on it, adds the new user to the authorized end-user database.

Thus, it will be understood that an administrative user can add a new user, edit that users personal information and grant that new user access to the electronic enhancements associated with printed book 20. The administrative user interface provides other substantial functionality, as is evident from FIG. 11. Such functions include the facilities to authorize a publisher to access or add titles to the Zuri™ system, to authorize another administrative user, to establish an administrative user's rights of access and control, to generate reports and to manage the instant administrative user's own account.

Those of skill in the art will appreciate that other screens are similarly laid out to provide full functionality for each of the listed menu items, thereby to prompt and facilitate data and control entry by the administrative user in managing end-users, publishers and other administrative users. Those of skill in the art also will appreciate that other functions and alternative layouts may be provided in the administrative user interface depending, in part, to the access and control rights granted to each administrative user of the system. All such variations to the interface are within the spirit and scope of the invention.

The administrative user of invented Zuri™ system 35 can grant various rights of use to various other users, including at least end-users, publishers and other administrative users, as shown. Those of skill in the art will appreciate that the invented system also may permit the administrative user to grant various rights of use to imprints, authors, advertisers and other partners. Read-only rights may be granted on a need-to-know basis and read/write rights may be granted on a need-to-access basis for the various users. For end-users, as described above, restricted or unrestricted rights of access may be granted depending upon whether the user has completed all the required registration for him or herself or the specific printed book title and whether the end-user has approved all subscription agreement terms. Only trusted publishers or administrative users should be granted access rights, and then only to specific titles for which they are responsible and under contract.

For example, the top level administrative user holds the most extensive access rights, in accordance with one embodiment of the invention. The top level administrative user therefore has the ability to add and modify the rights of those administrative rights at lower levels. In one such scenario, a top level administrative user may convey rights to a publisher to add new titles and control all modifications to titles added by that publisher. Furthermore, thee rights allocated to the administrative user for that publisher could grant all or part of those rights to even lower level administrative users. Those of skill in the art will appreciate that this hierarchy facilitates the allocation of certain duties and responsibilities to the appropriate personnel. To illustrate further, a publisher may desire to have a particular party granted administrative user rights to add all of the audio enhancements to three or four of the titles the publisher has added to the Zuri™ system, yet to have no other access or control rights.

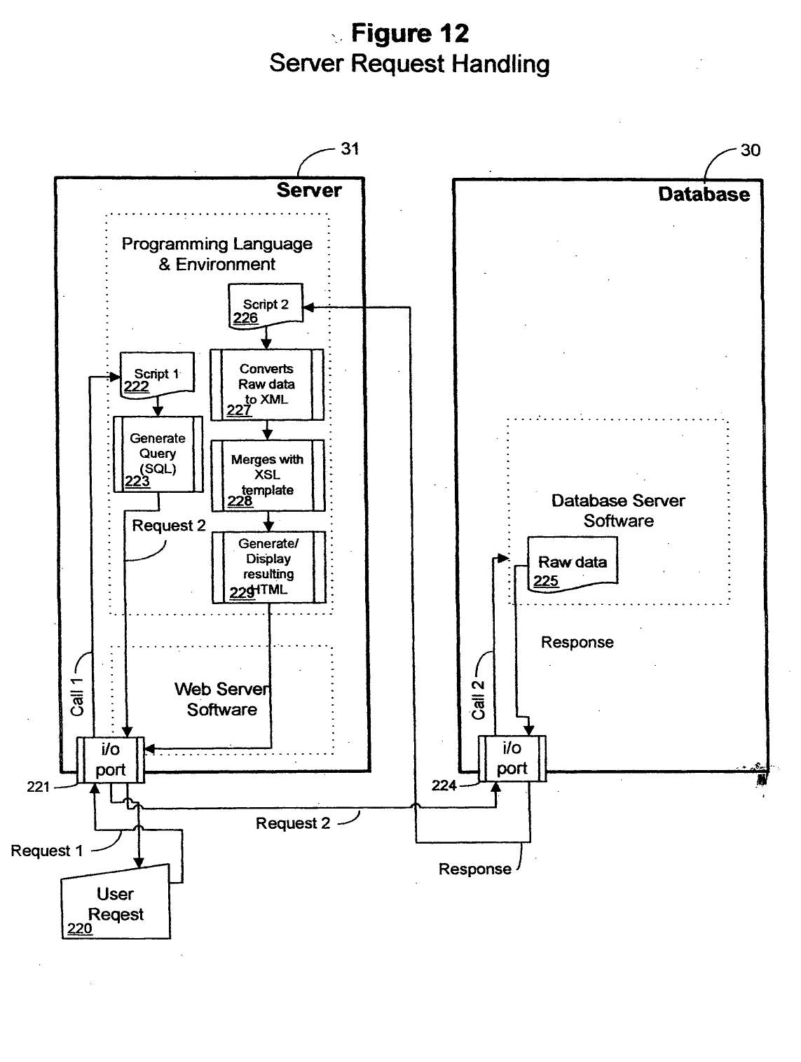

FIG. 12 is a schematic block/flow diagram illustrating one example of server request handling and database provisioning of access requests. Server 31 and database 30 (refer briefly to FIG. 1) cooperate via a query/response and series of calls to handle end-user or administrative user requests and to provide responses by way of making electronic data or content available to authorized administrative users, end-users or readers of printed book 20. A user request at block 220 is input as Request 1 to an input/output (I/O) port 221, as indicated. I/O port 221 in turn makes Call 1 to Script 1 (block 222) within the Programming Language & Environment block. Those of skill in the art will appreciate that I/O port 221 represents a state-of-the-art network port utilizing fill-duplex, high-speed and high-bandwidth connection features.

Script 1 invokes the generation of a query utilizing a Standard Query Language (SQL) at block 223, which goes through I/O port 221 and conveys Request 2 to database 30 via I/O port 224 (the functional equivalent of I/O port 221). I/O port 224 then conveys Call 2 to the database server software which processes Call 2 within database 30 where raw data 225 resides on a mass storage device or in another suitable high-capacity memory. Those of skill in the art will appreciate that raw data 225 include end-user data, transaction data, system activity data and a wide variety of data related to Zuri™ system status and usage. If a request is received to view on-line electronic embodiment 49 (see FIG. 2) of printed book 20, including, for example, URLs (links or pathnames to external resources) and/or content itself including multimedia and other digital enhancements, database 30 may directly supply such enhancements from raw data 225 and/or may forward the request to another server such as public front server 28 (refer to FIG. 1).

Raw data 224 returns a Response through I/O port 224 to a Script 2 (block 226) in server 31. Script 2 invokes a conversion of the data received from raw data 225 to Extensible Markup Language (XML) or another suitable form at block 227. At block 228, the resulting XML data are merged with a Extensible Stylesheet Language (XSL) template to produce HyperText Markup Language (HTML) data. At block 229, the resulting HTML or another suitable form of data are generated and optionally displayed or otherwise readied for export via Web Server Software to the end-user. The HTML or equivalent data form is exported via I/O port 221 to User Request block 220 for viewing by an end-user. Accordingly, the server request handling mechanism illustrated in FIG. 12 manages requests and provides enhanced electronic contents and other information to an end-user reading a printed book in front of his or her desktop computer, laptop, PDA, smart mobile phone or like interactive device providing at least limited key entry and display functions.

Those of skill in the art will appreciate that the use of XML, or equivalent, and XSL templates to produce HTML displays makes possible very general-purpose and robust server request handling. This approach utilizes a method of programming that allows new functional components or features to be easily added. The resulting flexibility enables integration with any system via functional APIs. It also supports content deployment that is purpose-agnostic (not limited by the viewing device). Finally, this open design can speak across multiple servers regardless of geographic location, which ensures that the system can scale to accommodate fast usage growth.

Other features of the invention that are contemplated include permitting consumer-generated identification codes; providing accounting administrative user interfaces; providing send-this-page-to-a-friend support; permitting addition of supplements by any one or more of publishers, imprints, authors, titles and chapters; providing a calendaring function for the reader end-user or the administrative end-user; providing consumer-customized titles for, e.g. educators; supporting custom home pages; promoting free viewing for some end-users; providing tie-ins or links to music download and use licenses and/or vendors; recognizing in-page HTML links; facilitating the integration into the Zuri™ system of additional services and products by third party providers; providing rights management tools to publishers, authors and other content rights owners; supporting galley views for publishers; supporting multiple context-relevant advertisements per page; providing access to ISBN databases; integrating enhanced printed-book or other product fulfillment; supporting predefined report types; providing a standard report generation user interface for publishers and/or administrative users; improving error handling; and providing a frequently asked questions (FAQs) or query/response window in the end-user interface.

In summary, it may be seen that the invented system, method and apparatus provides unprecedented but controlled access for authorized readers to virtually unlimited multimedia contents that greatly enhance the reading adventure by supplementing and even animating the printed book. Nevertheless, the impact on the printed book publishing world is minimal, whether for a new title or for a new edition of an old title. Indeed, the publishing world is enhanced by the provision of a set of advanced and intuitive multimedia contents enhancement tools. E-commerce in publishing takes a huge step forward by the provision of marketing and merchandising links that may be found within the multimedia contents surrounding the printed book.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that the method, system and apparatus of the invention may be implemented by a computer or microprocessor process in which instructions are executed, the instructions being stored for execution on a computer-readable medium and being executed by any suitable instruction processor.

Accordingly, one embodiment of the invention in terms of the invented system and method has been described in detail above. The detailed description is intended to illustrate the invention and not to limit it. Thus, alternative embodiments are contemplated, and all such alternative embodiments are deemed to be within the spirit and scope of the invention defined by the claims below.

1. A publishing method comprising:
distributing one or more bound volumes of printed material of a given title each bearing visible indicia including an accession code that uniquely identifies the given printed-book title;
providing on-line bound-volumes-of-printed-material-correlative electronic content to an end-user to whom the one or more bound volumes of printed material are distributed; and
controlling access by the end-user to the on-line electronic content by validating on-line entry of the accession code by the end-user.

2. The method of claim 1, wherein the visible indicia also includes link information indicating a virtual on-line bound-volume-of-printed-material-correlative electronic content registration location.

3. The method of claim 2, wherein said controlling includes permitting access by the end-user at the registration location to only defined portions of the on-line electronic content until the end-user meets defined on-line registration requirements.

4. A method for access to and exploration of an electronic multimedia information system via a printed-book to a plurality of mediums comprising the steps of:
developing multimedia content or converting existing multimedia content employing a method that can immediately be published regardless of the form factor or construction of the disseminating device;
publishing a static version of the multimedia content onto a form factor comprising a printed book wherein the printed book serves as the primary means of navigating the multimedia information in the electronic form factors;
providing a unique identifying code with each printed book employing a plurality of methods for accessing the stored electronic multimedia data;
posting the multimedia content at an internet address or pointer location;
providing the internet address or pointer to the multimedia content with each printed book that is unique to that particular title;
employing a plurality of computer devices to determine access privileges to the electronic embodiment of the multimedia content;
employing a plurality of computer devices to provide access to the electronic embodiment of the multimedia content with said designated controls;
employing a plurality of computer devices to display the entirety of the electronic multimedia content represented by the printed book, two pages per view;
employing a plurality of input devices to scroll the electronic multimedia contents forward or backward in two-page increments;
employing a plurality of computer devices to designate controls to jump to any page of the electronic embodiment of the multimedia content;
employing a plurality of computer devices to display said multimedia content to the user.

5. The method of claim 4, wherein the full complement of multimedia content is available beyond that which is statically captured in the printed book.

6. The method of claim 4, wherein the imagery printed in the book is animated in the electronic embodiment.

7. The method of claim 4, wherein the printed book requires no content or format revision during either the developing step or the publishing step.

8. The method of claim 4, wherein the password and linking information is printed in the book such that it is prominently visible to the reader.

9. The method of claim 4, wherein the access to the on-line information through the purchase of an individual printed book is restricted to a single user for a defined period that is renewable.

10. The method of claim 4, wherein the user can view all of the previous purchases of printed books associated with the user and the date of expiration of any current access privileges to the electronic multimedia information.

11. The method of claim 4, wherein the access to the on-line information through the purchase of an individual printed book by a qualifying institution is restricted to a defined number of simultaneous on-line users for a specified period that is renewable.

12. The method of claim 4 which further comprises:
incrementally rewarding a user who voluntarily enters personal demographic or geographic data or other information at defined data entry milestones, the rewarding taking the form of points earned by the user for later valuable redemption.

13. The method of claim 4 in which the printed-book is a textbook and in which the users are one or more students, wherein the developing of multimedia content is by an instructor and wherein the providing of a common internet address is temporal and associable with a given educational term and wherein the employing of computer devices to display said multimedia content is by and to the one or more students only for the given educational term.

14. An enhanced-book publishing system comprising:
multimedia resources containing a facsimile copy of a printed book and other printed book subject matter-relatable resources, the resources identifiable by an accession code stored in a database;
an on-line distribution mechanism enabling a reader of the printed book to access the facsimile copy of the printed book and the resources within the multimedia resources by comparing an accession code entered by the reader to the accession code in the database.

15. The system of claim 14 which further comprises:
a hardcopy of the printed book corresponding with the facsimile copy thereof, the hardcopy bearing visible indicia including an accession code enterable by the reader to identify and access the multimedia resources.

16. The system of claim 14 which further comprises:
a printed book distribution mechanism for distributing one or more hardcopies of the printed book to one or more readers, the printed book distribution mechanism including a mechanism for assigning the accession code and for affixing the visible indicia including the accession code to the one or more hardcopies of the printed book.

17. The system of claim 16, wherein said on-line distribution mechanism is configured to restrict access to said multimedia resources by an unauthorized reader who has not legitimately obtained the hardcopy of the printed book via said printed book distribution mechanism.

18. The system of claim 14, wherein said on-line distribution mechanism comprises:
a server configured in response to a user request to generate a database request and to await a database response, said server being scripted to convert raw data to an intermediate Extensible Markup Language (XML) data format for merging with a Extensible Stylesheet Language (XSL) template to produce a hypertext markup language (HTML) or equivalent form display for exporting to the user, and
a database operatively connected to said server, the database including raw data and instructions residing in a memory and executing in a processor, the raw data representing the multimedia resources, the instructions representing a request/response mechanism responsive said server and configured for supplying a response including the raw data in response to a request from said server,
said server and said database responding to a user request for said multimedia resources by supplying the same in HTML display form.

19. The system of claim 14 which further comprises:
an on-line user registration mechanism for registering a new reader, and
an incremental affinity mechanism operatively coupled with said user registration mechanism for incrementally rewarding the new reader if the new reader enters personal demographic or geographic data or other information at defined data entry milestones during use of said user registration mechanism, the reward taking the form of points earned by the reader for later valuable redemption.

20. The system of claim 14 which further comprises:
an administrative user interface operatively coupled with said on-line distribution mechanism, said interface configured to organize said multimedia resources hierarchically by two or more of publisher, author, title, chapter and page into an ordered array of folders represented by icons in an interface window, whereby a folder icon when opened enables an administrative user to drag and drop selected ones of said multimedia resources into the corresponding folder to add the selected multimedia resources selectively to one or more of the publisher, author, title, chapter and page folders.

21. The system of claim 20, wherein said interface is configured further for adding one or more new publishers, authors and titles to the virtual folders and for adding one or more new readers to a database of registered end-users of said system.

22. The system of claim 14 which further comprises:
a reader interface operatively coupled with said on-line distribution mechanism, said interface configured to enable a user to register as a new reader, to browse a list of one or more registered titles, to add one or more new titles to the list of one or more registered titles, to browse the facsimile copy of a particular one of the one or more registered titles and to access selected multimedia resources associated with a particular registered title.
